(19) United States
(12) Patent Application Publication
(10) Pub. No.: US 2014/0200322 A1
(43) Pub. Date: Jul. 17, 2014

(54) PROCESSES FOR PREPARING DIKETOPYRROLOPYRROLE COPOLYMERS

(71) Applicant: XEROX CORPORATION, Norwalk, CT (US)

(72) Inventors: Anthony James Wigglesworth, Oakville (CA); Yiliang Wu, Oakville (CA); Jennifer A. Coggan, Kitchener (CA)

(73) Assignee: XEROX CORPORATION, Norwalk, CT (US)

(21) Appl. No.: 13/740,800

(22) Filed: Jan. 14, 2013

(51) Int. Cl. C08G 69/42

(52) U.S. Cl. CPC C08G 69/42
USPC 528/8

(57) ABSTRACT

Processes for preparing diketopyrrolopyrrole (DPP) copolymers are disclosed. A Suzuki polycondensation method is used in which a DPP monomer is reacted with an aryl comonomer using a palladium catalyst in a solvent. The solvent contains an organic phase and an aqueous phase. Reaction conditions are optimized.

### BACKGROUND

The present disclosure relates to processes for preparing diketopyrrolopyrrole (DPP) copolymers. The copolymers, electronic devices using such copolymers, and methods for preparing such electronic devices are also disclosed.

Diketopyrrolopyrrole (DPP) copolymers are a promising class of high-performance semiconducting copolymers with potential applications in various electronic devices, such as solution-processed photovoltaic devices and organic thin-film transistors (OTFTs).

The Stille polycondensation reaction is often used to prepare DPP-based copolymers. This type of reaction requires the use of organotin compounds as a reactant, and those organotin compounds are toxic and expensive to produce. In addition, this reaction cannot be scaled up because a byproduct of the reaction is a highly toxic trimethyltin halide byproduct, which is difficult and unsafe to handle at larger scales.

It would be desirable to provide safe, reliable and scalable method for producing high-molecular weight DPP copolymers.

### BRIEF DESCRIPTION

The present disclosure provides, in various embodiments, processes for preparing DPP copolymers using an optimized Suzuki polycondensation reaction. Generally, a DPP monomer is reacted with an aryl comonomer (e.g. an aryl boronate) using a palladium catalyst in a reaction mixture containing a solvent. The reaction mixture is reacted to form the DPP copolymer. The polymerization reaction is predominantly free of tin. Certain optimizations are described herein.

Disclosed in various embodiments herein is a process for preparing a diketopyrrolopyrrole copolymer, comprising: receiving a reaction mixture containing a diketopyrrolopyrrole monomer, an aryl comonomer, a palladium catalyst, and a solvent; and reacting the reaction mixture to form the diketopyrrolopyrrole copolymer.

The diketopyrrolopyrrole monomer may have the structure of Formula (I):

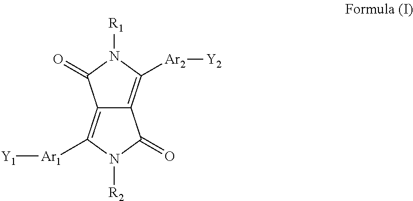

wherein Ar₁ and Ar₂ are independently aryl, substituted aryl, heteroaryl, or substituted heteroaryl;
R₁ and R₂ are independently hydrogen, alkyl, substituted alkyl, poly(ethylene glycol), poly(propylene glycol), aryl, substituted aryl, heteroaryl, or substituted heteroaryl; and
Y₁ and Y₂ are independently halogen.

In particular embodiments, Ar₁ and Ar₂ are independently selected from the group consisting of thiophene, furan, thienothiophene, and selenophene.

The aryl comonomer may be an aryl boronate having the structure of Formula (III):

BE-Ar″-BE Formula (III)

wherein BE is selected from the group consisting of:

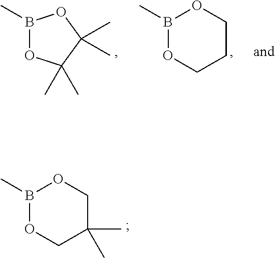

and wherein Ar″ is selected from the group consisting of:

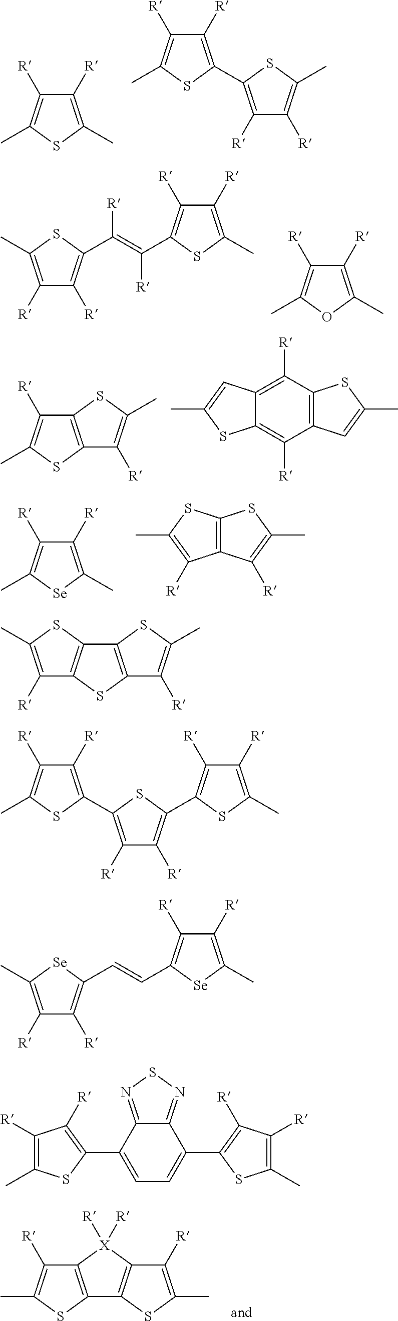

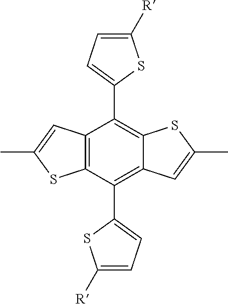

wherein each R′ is independently selected from hydrogen, alkyl, substituted alkyl, poly(ethylene glycol), poly(propylene glycol), aryl, substituted aryl, heteroaryl, substituted heteroaryl, halogen, alkoxy, alkylthio, trialkylsilyl, —CN, or —NO₂; and X is C or Si.

The palladium catalyst may be present in an amount of from about 3 mole % to about 5 mole % of the reaction mixture.

The solvent can include an organic phase and an aqueous phase. The organic phase may be selected from anisole, toluene, ethylbenzene, o-xylene, m-xylene, p-xylene, trimethylbenzene, mesitylene, tetrahydronapthalene, and mixtures thereof. The aqueous phase may include a base selected from K₂CO₃, K₃PO₄, KHCO₃, Na₂CO₃, NaHCO₃, and mixtures thereof. The volume ratio of organic phase to aqueous phase can be from about 10:1 to about 2:1. In particular embodiments, the solvent is an about 3:1 mixture (v/v) of (i) either toluene or o-xylene with (ii) an aqueous solution containing about 1 to about 10 molar equivalents of a base.

The reacting step generally includes a heating of the reaction mixture. The reacting may occur at a temperature of from 80° C. to 120° C. The reacting can occur for a time period of from about 6 hours to about 36 hours. The heating of the reaction mixture may occur by microwave heating.

Sometimes, the reaction mixture further comprises a phase transfer catalyst.

The process may further comprise deoxygenating the reaction mixture prior to the reacting.

In particular embodiments, the palladium catalyst has the structure of Formula (IV).

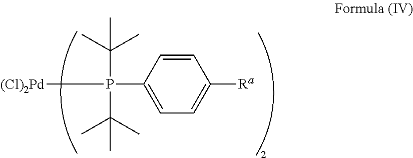

wherein R^{a} is H, —N(CH₃)₂, or —CF₃.

In specific iterations of the process, the palladium catalyst is present in the amount of from about 3 mole % to about 5 mole % of the reaction mixture; the palladium catalyst has the structure of Formula (IV) above; the solvent is a 3:1 mixture (v/v) of o-xylene with an aqueous solution containing from 1 to 10 molar equivalents of a base; the reaction mixture further comprises a phase transfer catalyst; and the reacting occurs at a temperature of about 80° to about 120° C. for a time period of at least 6 hours.

The resulting diketopyrrolopyrrole copolymer may have a number average molecular weight (Mn) of at least 10,000 when measured using high-temperature gel permeation chromatography in trichlorobenzene at 140° C. The resulting diketopyrrolopyrrole copolymer may alternatively have a polydispersity index (PDI) of at least 2.0.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a diagram illustrating the processes of the present disclosure.

FIG. 2 is a picture of a thin film transistor that can incorporate the DPP copolymer formed using the processes of the present disclosure.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range of “from about 2 to about 10” also discloses the range “from 2 to 10.”

The term “comprising” is used herein as requiring the presence of the named component and allowing the presence of other components. The term “comprising” should be construed to include the term “consisting of”, which allows the presence of only the named component, along with any impurities that might result from the manufacture of the named component.

The present disclosure relates to processes for preparing diketopyrrolopyrrole (DPP)-based copolymers using an optimized Suzuki polycondensation method. These processes are predominantly free of tin, or in other words they do not use tin based compounds as a reactant. The Suzuki reaction uses non-toxic organoboron compounds as a reactant and does not produce any toxic byproducts during the polymerization reaction. Methods using conventional palladium (Pd)-based catalysts (e.g. Pd(PPh₃)₄) often suffer from low yield and only produce low molecular weight oligomers which have much lower performance than identical materials produced using the Stille polycondensation method. The processes of the present disclosure use highly active Pd-catalysts substituted with aryl-di-tertbutyl-phosphine ligands. Using this class of catalysts, DPP-based copolymers with high number average molecular weight (Mn) can be prepared in good yield that cannot be obtained using traditional catalysts for the Suzuki polycondensation method. The DPP-based copolymers also have performance that meets or exceeds the performance of such copolymers produced using the Stille polycondensation method.

Generally, in the processes of the present disclosure, a diketopyrrolopyrrole (DPP) monomer is reacted with an aryl comonomer to form the DPP copolymer. A palladium catalyst is used to catalyze the reaction. The DPP monomer, aryl comonomer, and palladium catalyst are combined in a solvent to form a reaction mixture. The reaction mixture is then reacted to form the DPP copolymer.

The diketopyrrolopyrrole (DPP) monomer used in the reaction mixture may have the structure of Formula (I):

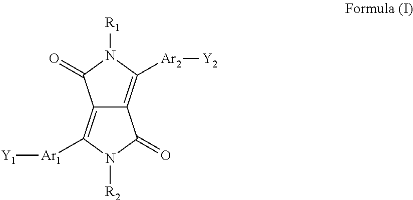

wherein Ar₁ and Ar₂ are independently aryl, substituted aryl, heteroaryl, or substituted heteroaryl; R₁ and R₂ are independently hydrogen, alkyl, substituted alkyl, poly(ethylene glycol), poly(propylene glycol), aryl, substituted aryl, heteroaryl, or substituted heteroaryl; and Y₁ and Y₂ are independently halogen.

The term “alkyl” refers to a radical composed entirely of carbon atoms and hydrogen atoms which is fully saturated. The alkyl radical may be linear, branched, or cyclic. The alkyl radical can be univalent or divalent, i.e. can bond to one or two different non-hydrogen atoms.

The term “poly(ethylene glycol)” refers to a radical of the formula—(OCH₂CH₂)ₘOR, where m is an integer, and R is either hydrogen or alkyl. Exemplary poly(ethylene glycol)s include tri(ethylene glycol) monomethyl ether (m=3, R═CH₃) and tetra(ethylene glycol) monomethyl ether (m=4, R═CH₃).

The term “poly(propylene glycol)” refers to a radical of the formula —(OCH₂CH₂CH₂)ₘOR, where m is an integer, and R is either hydrogen or alkyl.

The term “aryl” refers to an aromatic radical composed entirely of carbon atoms and hydrogen atoms. When aryl is described in connection with a numerical range of carbon atoms, it should not be construed as including substituted aromatic radicals. For example, the phrase “aryl containing from 6 to 10 carbon atoms” should be construed as referring to a phenyl group (6 carbon atoms) or a naphthyl group (10 carbon atoms) only, and should not be construed as including a methylphenyl group (7 carbon atoms). The aryl radical may be univalent or divalent.

The term “heteroaryl” refers to a cyclic radical composed of carbon atoms, hydrogen atoms, and a heteroatom within a ring of the radical, the cyclic radical being aromatic. The heteroatom may be nitrogen, sulfur, or oxygen. Exemplary heteroaryl groups include thienyl, pyridinyl, and quinolinyl. When heteroaryl is described in connection with a numerical range of carbon atoms, it should not be construed as including substituted heteroaromatic radicals. Note that heteroaryl groups are not a subset of aryl groups.

The term “substituted” refers to at least one hydrogen atom on the named radical being substituted with another functional group, such as halogen, —CN, —NO₂, —COOH, and —SO₃H. An exemplary substituted alkyl group is a perhaloalkyl group, wherein one or more hydrogen atoms in an alkyl group are replaced with halogen atoms, such as fluorine, chlorine, iodine, and bromine. Besides the aforementioned functional groups, an alkyl group may also be substituted with an aryl or heteroaryl group. An aryl or heteroaryl group may also be substituted with alkyl or alkoxy. Exemplary substituted aryl groups include methylphenyl and methoxyphenyl. Exemplary substituted heteroaryl groups include 3-methylthienyl.

Generally, each alkyl group independently contains from 6 to 30 carbon atoms. Similarly, each aryl group independently contains from 4 to 24 carbon atoms. A heteroaryl group contains from 2 to 30 carbon atoms.

Some exemplary alkyl groups include methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, cyclopentyl, cyclohexyl, cycloheptyl, and isomers thereof such as 2-ethylhexyl, 2-hexyldecyl, 2-octyldodecyl, or 2-decyltetradecyl.

Some exemplary aryl and substituted aryl groups include phenyl, polyphenyl, and naphthyl; alkoxyphenyl groups, such as p-methoxyphenyl, m-methoxyphenyl, o-methoxyphenyl, ethoxyphenyl, p-tert-butoxyphenyl, and m-tert-butoxyphenyl; alkylphenyl groups such as 2-methylphenyl, 3-methylphenyl, 4-methylphenyl, ethylphenyl, 4-tert-butylphenyl, 4-butylphenyl, and dimethylphenyl; alkylnaphthyl groups such as methylnaphthyl and ethylnaphthyl; alkoxynaphthyl groups such as methoxynaphthyl and ethoxynaphthyl; dialkylnaphthyl groups such as dimethylnaphthyl and diethylnaphthyl; and dialkoxynaphthyl groups such as dimethoxynaphthyl and diethoxynaphthyl, other aryl groups listed as exemplary M groups, and combinations thereof.

Some exemplary heteroaryl groups include thiophene, thienothiophene, furan, selenophene, benzodithiophene, oxazole, isoxazole, pyridine, thiazole, isothiazole, imidazole, triazole, pyrazole, furazan, thiadiazole, oxadiazole, pyridazine, pyrimidine, pyrazine, indole, isoindole, indazole, chromene, quinoline, isoquinoline, cinnoline, quinazoline, quinoxaline, naphthylidine, phthalazine, purine, pteridine, thienofuran, imidazothiazole, benzofuran, benzothiophene, benzoxazole, benzthiazole, benzthiadiazole, benzimidazole, imidazopyridine, pyrrolopyridine, pyrrolopyrimidine, pyridopyrimidine, and combinations thereof.

Each Ar₁ and Arₑ unit may be independently selected from the group consisting of the following structures:

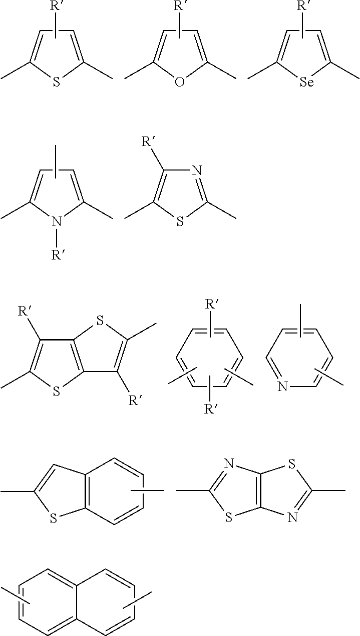

and combinations thereof, wherein each R′ is independently selected from hydrogen, alkyl, substituted alkyl, poly(ethylene glycol), poly(propylene glycol), aryl, substituted aryl, heteroaryl, substituted heteroaryl, halogen, alkoxy, alkylthio, trialkylsilyl, —CN, or —NO₂.

The term “alkoxy” refers to an alkyl radical which is attached to an oxygen atom, e.g. —O—CₙH₂ₙ₊₁. The oxygen atom attaches to the core of the compound.

The term “alkylthio” refers to an alkyl radical which is attached to a sulfur atom, e.g. —S—CₙH₂ₙ₊₁. The sulfur atom attaches to the core of the compound.

The term “trialkylsilyl” refers to a radical composed of a tetravalent silicon atom having three alkyl radicals attached to the silicon atom, i.e. —Si(R)₃. The three alkyl radicals may be the same or different. The silicon atom attaches to the core of the compound.

The term “halogen” refers to fluorine, chlorine, iodine, and bromine.

In particular embodiments, Ar₁ and Ar₂ are independently selected from:

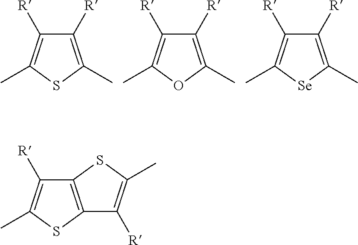

and combinations thereof, wherein each R′ is as described above.

In more specific embodiments, the diketopyrrolopyrrole (DPP) monomer may have the structure of Formula (II):

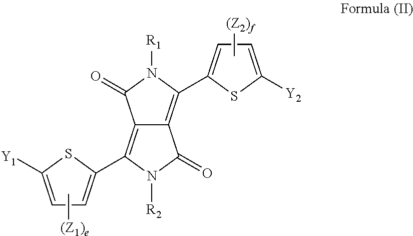

wherein R₁ and R₂ are independently hydrogen, alkyl, substituted alkyl, poly(ethylene glycol), poly(propylene glycol), aryl, or substituted aryl; Y₁ and Y₂ are independently halogen; each Z₁ and Z₂ is independently alkyl, substituted alkyl, aryl, substituted aryl, heteroaryl, substituted heteroaryl, halogen, alkoxy, alkylthio, trialkylsilyl, —CN, or —NO₂; and e and f are independently from 0 to 2.

In particular embodiments of Formula (I) and Formula (II), Y₁ and Y₂ are bromine. In some other particular embodiments of Formula (I) and Formula (II), R₁ and R₂ are hydrogen or alkyl.

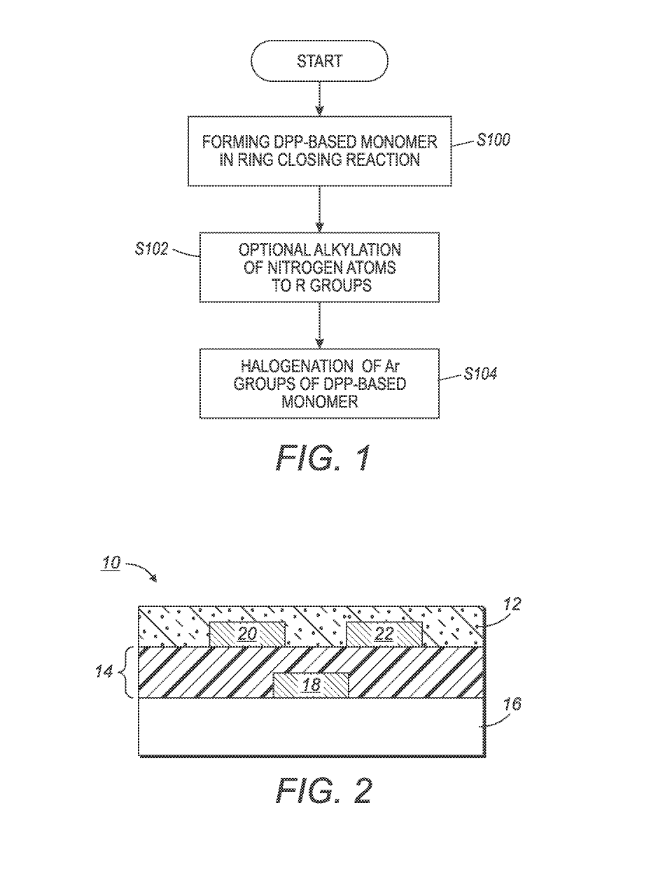

The diketopyrrolopyrrole (DPP) monomer can be prepared by a three-step process, as illustrated in FIG. 1. At step S100, a DPP (diketopyrrolopyrrole) moiety may be formed by reacting 2 moles of an appropriate nitrile or a Schiff base with one mole of a succinic acid diester in the presence of a base and an organic solvent. For example, a carbonitrile (Ar—CN) for forming the selected Ar group (e.g., thiophenecarbonitrile) is reacted with a succinate (e.g. diisopropyl succinate or di-n-butyl succinate) under suitable conditions for ring closure of the DPP moiety to form a monomer M1 of the general formula:

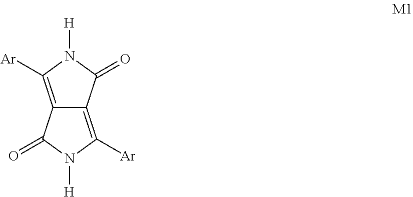

where Ar is as defined above.

For example, step S100 may be carried out in solution in the presence of a sodium alkoxide, such as t-C₅H₁₁ONa, which may be formed in situ, followed by neutralization with an organic acid, such as glacial acetic acid. The reaction may be performed at a suitable reaction temperature, such as about 85° C.

At step S102, the H groups on the nitrogen atoms of the monomer (M1) obtained at step S100 may optionally be converted from H to a selected R group by reaction of the monomer with a halide of the formula R—Y, where R is as defined above (other than H) and Y is a halogen which may be selected from chlorine, bromine, and iodine. A monomer of the following structure (M2) is thus formed:

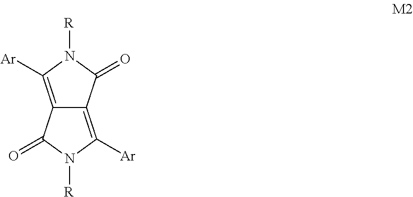

When R is aryl, substituted aryl, heteroaryl, or substituted heteroaryl, an optional palladium or copper catalyst may be required.

Step S102 may be performed in solution at a suitable reaction temperature, such as about 40 to 180° C. (e.g., about 120° C.). The reaction may be carried out in a suitable solvent, such as dimethylformamide, in the presence of an appropriate base, such as an alkali metal hydroxide or carbonate and an optional crown ether, such as 18-crown-6. Suitable bases include NaH, NaOH, KOH, t-BuONa, t-BuOK, Na₂CO₃, K₂CO₃ and the like. Usually, the molar ratio of the base to compound M1 is chosen in the range of from 0.5:1 to 50:1.

At step S104, the Ar groups are halogenated with a halogenating reagent, such as N-halosuccinimides, bromine, chlorine, or iodine, to form a monomer of the general formula:

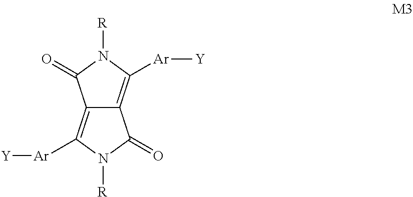

Y can be a halogen, such as bromine, chlorine, or iodine. Step S104 may be carried out in any suitable non-reactive medium, such as chloroform, e.g., at room temperature or above. This results in the DPP monomer of Formula (I) or Formula (II).

The aryl boronate used in the reaction mixture may have the structure of Formula (III):

BE-Ar″-BE Formula (III)

wherein BE represents the boronic portion, and Ar″ is a conjugated moiety. In particular embodiments, BE is selected from the group consisting of:

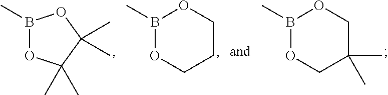

and Ar″ is selected from the group consisting of:

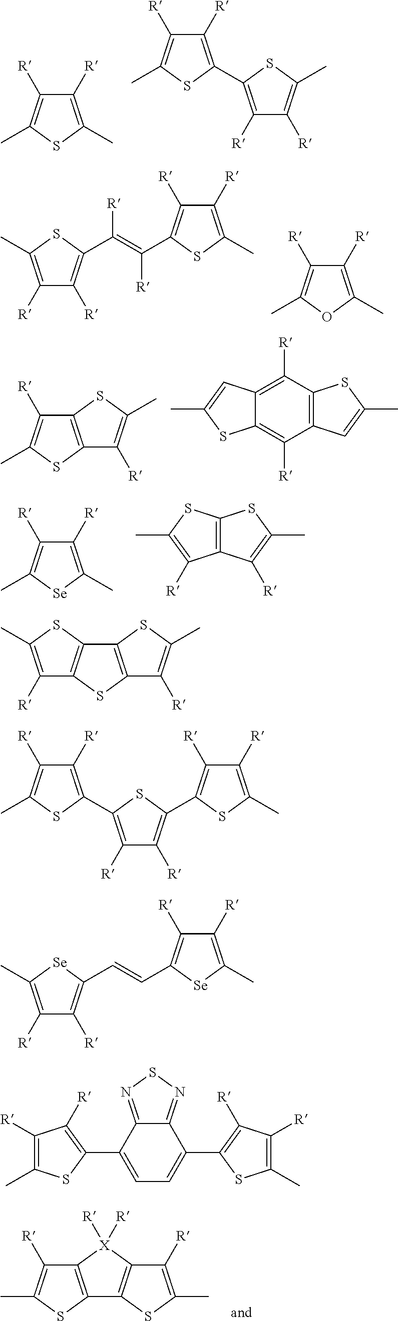

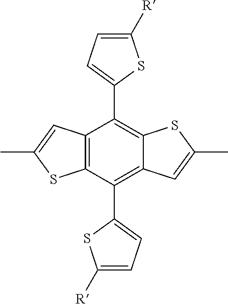

wherein each R′ is independently selected from hydrogen, alkyl, substituted alkyl, poly(ethylene glycol), poly(propylene glycol), aryl, substituted aryl, heteroaryl, substituted heteroaryl, halogen, alkoxy, alkylthio, trialkylsilyl, —CN, or —NO₂; and X is C or Si. In this regard, the cyclic boronates are preferred due to their stability under ambient conditions, ease of handling, and reactivity under the polymerization conditions.

In particular embodiments, Ar″ is selected from the group consisting of

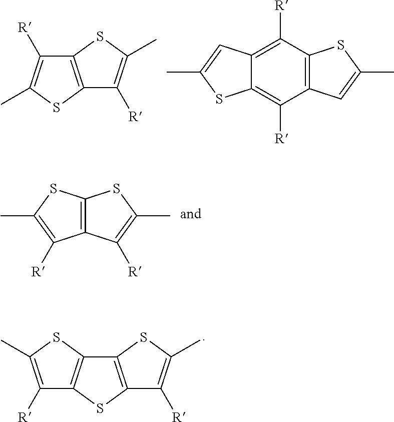

The palladium catalyst used in the reaction mixture contains a palladium metal atom which is substituted with aryl-di-tertbutyl-phosphine ligands. In particular embodiments, the palladium catalyst used in the reaction has the structure of Formula (IV):

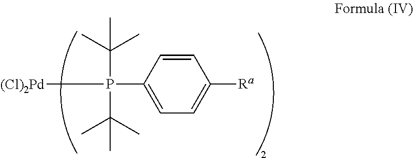

wherein R^{a} is H, —N(CH₃)₂, or —CF₃. In particular embodiments, the palladium catalyst used in the reaction is Pd-132, which has the structure shown below:

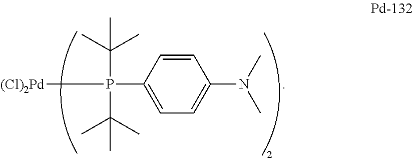

Pd-132 is especially suited for the polymerization reactions described herein.

The solvent used in the reaction mixture may include an organic phase and an aqueous phase (the two phases being immiscible with each other). The organic phase may be selected from anisole, toluene, ethylbenzene, o-xylene, m-xylene, p-xylene, xylene, 1,2,4-trimethylbenzene, mesitylene, tetrahydronaphthalene, and mixtures thereof of such water-immiscible organic solvents. Toluene and o-xylene are preferred for the organic phase.

The aqueous phase generally includes a base selected from K₂CO₃, K₃PO₄, KHCO₃, Na₂CO₃, NaHCO₃, and mixtures thereof. The base may be added in amounts sufficient to attain a starting pH (i.e. prior to reaction) of about 8 to about 14. If desired, a water-miscible solvent, such as dimethylformamide (DMF), dimethylacetamide (DMA), n-methylpyrrolidone (NMP), dioxolane, dioxane, or tetrahydrofuran (THF) may also be present in the liquid phase, or used instead of water. The aqueous phase neutralizes the acid that is generated during the polymerization reaction.

The volume ratio of organic phase to aqueous phase may be from about 10:1 to about 2:1. In specific embodiments, the solvent is a mixture of o-xylene with an aqueous solution containing about 1 to about 10 molar equivalents of a base, in a volume ratio of about 3:1 (organic:aqueous). In more specific embodiments, the aqueous solution contains about 2 to about 5 molar equivalents of the base. In a specific example, the aqueous solution is 2M aqueous K₂CO₃.

If desired, the reaction mixture may also include a phase transfer catalyst. An exemplary phase transfer catalyst is known by the name “aliquat 336” or “Starks' catalyst”, and is a quaternary ammonium salt containing a mixture of octyl and decyl sidechains. The phase transfer catalyst is usually present in small amounts.

The palladium catalyst is present in an amount of from about 3 mole % to about 5 mole % of the reaction mixture. The molar ratio of the diketopyrrolopyrrole (DPP) monomer to the aryl boronate is generally about 1:1.

The reaction mixture is generally deoxygenated to prevent catalyst poisoning. The reaction mixture is then reacted to form the DPP copolymer. The reaction typically involves heating the reaction mixture for a given time period. Agitation is useful. The reaction also generally occurs under an inert atmosphere, e.g. argon or nitrogen, again to prevent catalyst poisoning. In embodiments, the reaction mixture is heated to a temperature of from 80° C. to 120° C., including about 90° C. The reaction mixture is heated for a time period of from about 2 hours to about 96 hours, including a heating time period of about 18 to about 30 hours, or about 6 hours to about 36 hours. The reaction optimizes the catalyst loading, the aqueous base in the solvent, and the reaction time. The heating of the reaction mixture can be performed by placing the reaction mixture in a heating mantle, in an oil bath, on a heating block, or in a sand bath. However, an alternative method of heating is using microwave heating, which reduces the time that the heating needs to be applied.

The DPP copolymer is formed as a result of this reaction, and can subsequently be precipitated and purified. The resulting DPP copolymer can have a number average molecular weight (Mn) of at least 10,000. The resulting DPP copolymer may have a polydispersity index (PDI) of at least 2.0. It should be noted that every bond formed during the polymerization here is between two heteroaromatic rings.

Exemplary DPP copolymers that can be made using the processes of the present disclosure include those of Formulas (1)-(15):

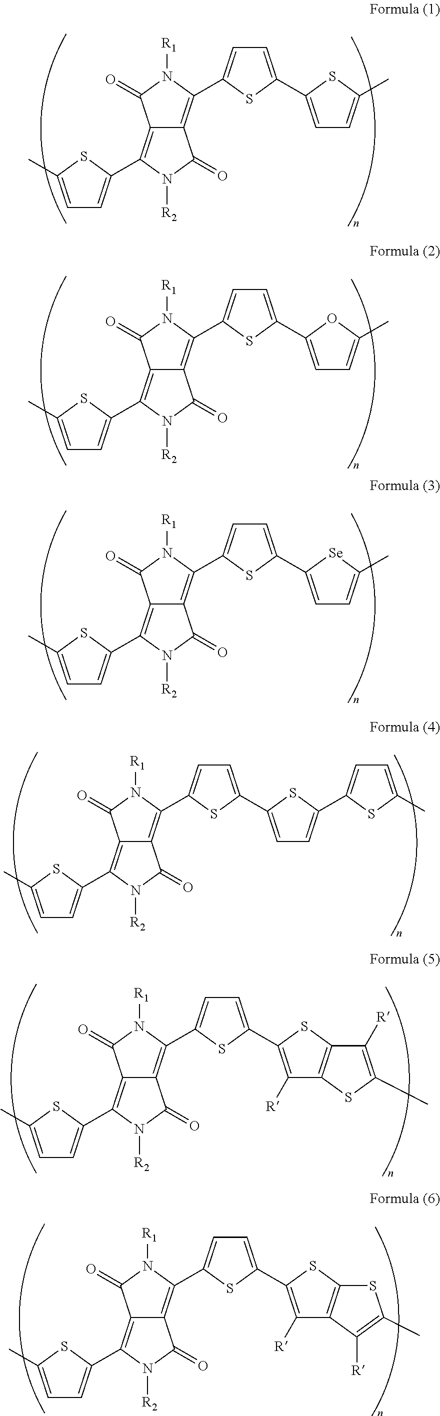

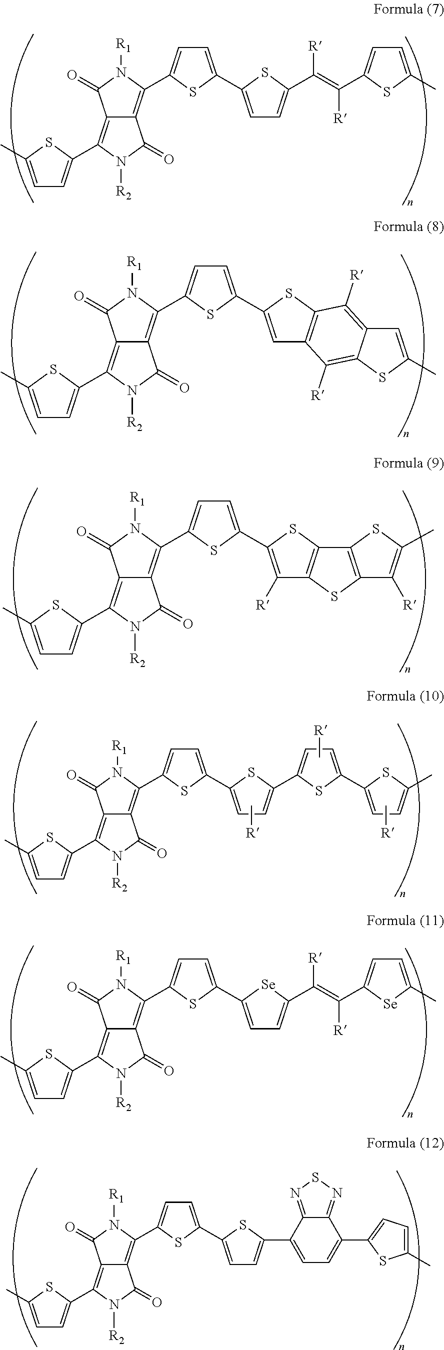

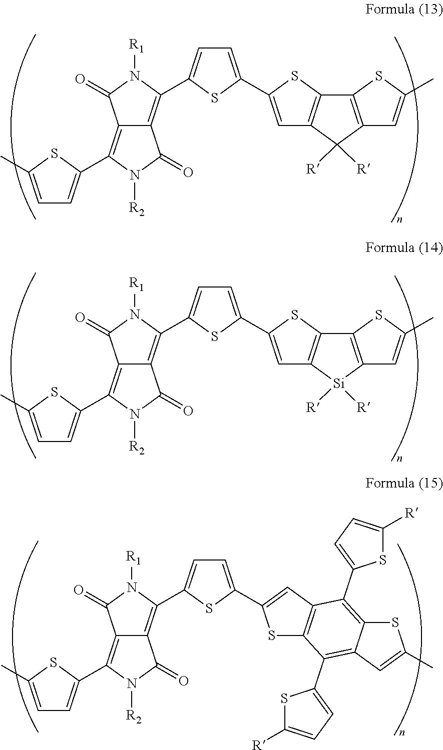

where R₁, R₂, and R′ are as defined above, and n is from 2 to about 5,000.

The DPP copolymers can be used as semiconducting polymers. Semiconductor compositions comprising the DPP copolymers are also disclosed. The semiconductor compositions may include a solvent in which the DPP copolymer is soluble. Exemplary solvents used in the solution may include chlorinated solvents such as chlorobenzene, chlorotoluene, dichlorobenzene, dichloroethane, chloroform, tetrachloroethane, and the like; alcohols and diols such as propanol, butanol, hexanol, hexanediol, etc.; hydrocarbons or aromatic hydrocarbons such as hexane, heptane, toluene, xylene, mesitylene, trimethyl benzene, ethyl benzene, tetrahydronaphthalene, decalin, methyl naphthalene, etc.; ketones such as acetone, methyl ethyl ketone, etc.; acetates, such as ethyl acetate; pyridine, tetrahydrofuran, and the like.

The semiconductor compositions can be used to form semiconducting layers in electronic devices such as, for example, thin film transistors, photovoltaic devices, light emitting diodes, light emitting transistors, sensors, and the like. In embodiment, the DPP copolymers can be used to form a layer of a thin film transistor or photovoltaic device.

FIG. 2 illustrates a bottom-gate bottom-contact TFT configuration. The TFT 10 comprises a substrate 16 in contact with the gate electrode 18 and a gate dielectric layer 14. The gate electrode 18 is depicted here atop the substrate 16, but the gate electrode could also be located in a depression within the substrate. It is important that the gate dielectric layer 14 separates the gate electrode 18 from the source electrode 20, drain electrode 22, and the semiconducting layer 12. The semiconducting layer 12 runs over and between the source and drain electrodes 20 and 22. The semiconductor has a channel length between the source and drain electrodes 20 and 22.

The semiconducting layer may be formed in an electronic device using conventional processes known in the art. In embodiments, the semiconducting layer is formed using solution depositing techniques. Exemplary solution depositing techniques include spin coating, blade coating, rod coating, dip coating, screen printing, ink jet printing, stamping, stencil printing, screen printing, gravure printing, flexography printing, and the like.

The semiconducting layer formed using the semiconductor composition can be from about 5 nanometers to about 1000 nanometers deep, including from about 20 to about 100 nanometers in depth. In certain configurations, the semiconducting layer completely covers the source and drain electrodes. The semiconductor channel width may be, for example, from about 5 micrometers to about 5 millimeters with a specific channel width being about 100 micrometers to about 1 millimeter. The semiconductor channel length may be, for example, from about 1 micrometer to about 1 millimeter with a more specific channel length being from about 5 micrometers to about 100 micrometers.

The performance of a TFT can be measured by mobility. The mobility is measured in units of cm²/V·sec; higher mobility is desired. The resulting TFT using the semiconductor composition of the present disclosure may have a field effect mobility of at least 0.1 cm²/V·sec. The TFT of the present disclosure may have a current on/off ratio of at least 10⁵.

A thin film transistor generally includes a substrate, an optional gate electrode, source electrode, drain electrode, and a dielectric layer in addition to the semiconducting layer.

The substrate may be composed of materials including but not limited to silicon, glass plate, plastic film or sheet. For structurally flexible devices, plastic substrate, such as for example polyester, polycarbonate, polyimide sheets and the like may be preferred. The thickness of the substrate may be from about 10 micrometers to over 10 millimeters with an exemplary thickness being from about 50 to about 100 micrometers, especially for a flexible plastic substrate and from about 0.5 to about 10 millimeters for a rigid substrate such as glass or silicon.

The dielectric layer generally can be an inorganic material film, an organic polymer film, or an organic-inorganic composite film. Examples of inorganic materials suitable as the dielectric layer include silicon oxide, silicon nitride, aluminum oxide, barium titanate, barium zirconium titanate and the like. Examples of suitable organic polymers include polyesters, polycarbonates, poly(vinyl phenol), polyimides, polystyrene, polymethacrylates, polyacrylates, epoxy resin and the like. The thickness of the dielectric layer depends on the dielectric constant of the material used and can be, for example, from about 10 nanometers to about 500 nanometers. The dielectric layer may have a conductivity that is, for example, less than about 10⁻¹² Siemens per centimeter (S/cm). The dielectric layer is formed using conventional processes known in the art, including those processes described in forming the gate electrode.

In the present disclosure, the dielectric layer may be surface modified with a surface modifier. Exemplary surface modifiers include organosilanes such as hexamethyldisilazane (HMDS), octyltrichlorosilane (OTS-8), octadecyltrichlorosilane (ODTS-18), and phenyltrichlorosilane (PTS). The semiconducting layer can be directly contacted with this modified dielectric layer surface. The contact may be complete or partial. This surface modification can also be considered as forming an interfacial layer between the dielectric layer and the semiconducting layer.

The gate electrode is composed of an electrically conductive material. It can be a thin metal film, a conducting polymer film, a conducting film made from conducting ink or paste, or the substrate itself, for example heavily doped silicon. Examples of gate electrode materials include but are not restricted to aluminum, gold, silver, chromium, indium tin oxide, conductive polymers such as polystyrene sulfonate-doped poly(3,4-ethylenedioxythiophene) (PSS-PEDOT), and conducting ink/paste comprised of carbon black/graphite. The gate electrode can be prepared by vacuum evaporation, sputtering of metals or conductive metal oxides, conventional lithography and etching, chemical vapor deposition, spin coating, casting or printing, or other deposition processes. The thickness of the gate electrode ranges for example from about 10 to about 200 nanometers for metal films and from about 1 to about 10 micrometers for conductive polymers. Typical materials suitable for use as source and drain electrodes include those of the gate electrode materials such as aluminum, gold, silver, chromium, zinc, indium, conductive metal oxides such as zinc-gallium oxide, indium tin oxide, indium-antimony oxide, conducting polymers and conducting inks. Typical thicknesses of source and drain electrodes are, for example, from about 40 nanometers to about 1 micrometer, including more specific thicknesses of from about 100 to about 400 nanometers.

Typical materials suitable for use as source and drain electrodes include those of the gate electrode materials such as gold, silver, nickel, aluminum, platinum, conducting polymers, and conducting inks. In specific embodiments, the electrode materials provide low contact resistance to the semiconductor. Typical thicknesses are about, for example, from about 40 nanometers to about 1 micrometer with a more specific thickness being about 100 to about 400 nanometers.

The source electrode is grounded and a bias voltage of, for example, about 0 volt to about 80 volts is applied to the drain electrode to collect the charge carriers transported across the semiconductor channel when a voltage of, for example, about +10 volts to about −80 volts is applied to the gate electrode. The electrodes may be formed or deposited using conventional processes known in the art.

If desired, a barrier layer may also be deposited on top of the TFT to protect it from environmental conditions, such as light, oxygen and moisture, etc. which can degrade its electrical properties. Such barrier layers are known in the art and may simply consist of polymers.

The various components of the OTFT may be deposited upon the substrate in any order. Generally, however, the gate electrode and the semiconducting layer should both be in contact with the gate dielectric layer. In addition, the source and drain electrodes should both be in contact with the semiconducting layer. The phrase “in any order” includes sequential and simultaneous formation. For example, the source electrode and the drain electrode can be formed simultaneously or sequentially. The term “on” or “upon” the substrate refers to the various layers and components with reference to the substrate as being the bottom or support for the layers and components which are on top of it. In other words, all of the components are on the substrate, even though they do not all directly contact the substrate. For example, both the dielectric layer and the semiconducting layer are on the substrate, even though one layer is closer to the substrate than the other layer. The resulting TFT has good mobility and good current on/off ratio.

The following examples are for purposes of further illustrating the present disclosure. The examples are merely illustrative and are not intended to limit devices made in accordance with the disclosure to the materials, conditions, or process parameters set forth therein. All parts are percentages by volume unless otherwise indicated.

### EXAMPLES

### Example 1

A series of commercially available Pd-catalysts were initially screened to identify a highly reactive and general catalyst for the SPC reaction. Those Pd-catalysts were: Pd(PPh₃)₄, Pd₂ dba₃/S-Phos; Pd₂ dba₃/John-Phos; Buchwald 2nd Generation Palladacycle; Pd-PEPPSI IPr; Pd(dtbpf)Cl₂; and Pd-132, wherein dba=dibenzyliene acetone and dtbpf=bis(di-tert-butylphosphino)ferrocene.

The catalysts were screened by performing a reaction according to Scheme 1, using Pd-132 to illustrate the reaction:

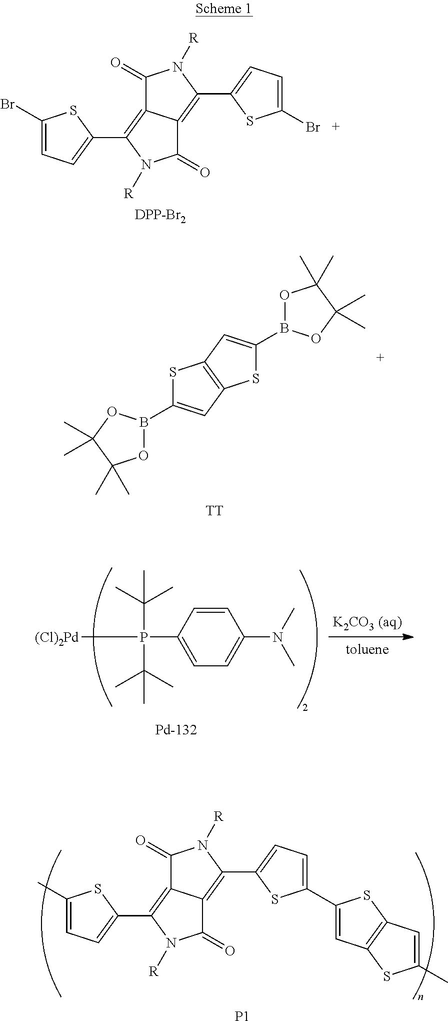

To a 100 mL 3-necked round bottom flask was added a 3:1 mixture of toluene and 2M aqueous K₂CO₃. 3-6 drops of a 50 wt % solution of aliquat 336 in toluene was added as a phase transfer catalyst. The flask was fitted with a condenser and the solvent mixture was deoxygenated for 30 minutes by bubbling with argon gas.

The flask was charged with the dibromide DPP—Br₂ (1.0 equivalents), boronic ester TT (1.01 equivalents) and Pd-132 (0.03 to 0.1 equivalents). The reaction was heated to an external temperature of 90° C. under an argon atmosphere and stirred at this temperature for 24 hours. After the polymerization was complete, the copolymers were end-capped by adding 2-bromothiophene (1.0 eq.) and stirring for 2 hours at 90° C., then adding 2-thiopheneboronic acid (1.0 eq.) and stirring for an additional 2 hours at 90° C. The heat was removed and the reaction mixture was cooled to room temperature.

The organic layer was separated and concentrated using a rotary evaporator. The crude copolymer P1 was precipitated with methanol and collected by vacuum filtration. The copolymer was purified by successive soxhlet extractions with methanol (6 hours, 95° C.), hexanes (18 hours, 90° C.) to remove lower molecular weight oligomers and impurities and then by extraction with CHCl₃ (2 hours, 90° C.) to extract the purified copolymer. The CHCl₃ extract was concentrated using a rotary evaporator and precipitated with methanol. The copolymer was collected by vacuum filtration and dried under high vacuum.

Many of the catalysts did not produce any polymer and had significant unreacted monomer DPP—Br₂ when examined using NMR. Those copolymers were not characterized further. Table 1 reports the isolated yield after purification by soxlet extraction for some palladium catalysts.

Based on the screening, Pd-132 (illustrated above) was selected as the palladium catalyst. The molecular weights were determined by high-temperature GPC (140° C., trichlorobenzene) calibrated with polystyrene standards.

TABLE 1

| | Reaction | Yield | Mn | |
|---|---|---|---|---|
| Catalyst | Time (hr) | (%) | (Daltons) | PDI |
| Pd-PEPPSI | 72 | 25 | 9,166 | 2.01 |
| Pd(dtbpf)Cl₂ | 24 | 50 | 7,491 | 2.78 |
| Pd-132 | 24 | 60 | 15,226 | 2.30 |

### Example 2

After determining that Pd-132 was an optimal palladium catalyst, other reaction conditions were varied. These included the catalyst loading, the identity of the solvent, and the reaction time. These results are reported in Table 2 below.

TABLE 2

| | Reaction | Catalyst | | Yield | Mn | |
|---|---|---|---|---|---|---|
| Sample | Time (hr) | loading (%) | Solvent | (%) | (Daltons) | PDI |
| A | 24 | 5 | Toluene | 60 | 15,226 | 2.30 |
| B | 24 | 3 | Toluene | 75 | 10,141 | 2.12 |
| C | 72 | 3 | Toluene | 60 | 10,206 | 1.97 |
| D | 24 | 3 | Dioxolane | 75 | 7,106 | 3.50 |
| E | 24 | 3 | o-Xylene | 87 | 15,033 | 2.67 |

Samples A and B varied the catalyst loading. With increased loading, the yield declined, but the Mn and the PDI increased.

Samples B and C varied the reaction time. A longer reaction time did not significantly increase the yield or Mn.

Samples B, D, and E varied the solvent. Comparing B to D, the yields were the same, but the PDI differed significantly. Sample E had both the highest yield and the highest Mn.

### Example 3

### Device Fabrication and Testing

OTFT devices were fabricated on a silicon wafer substrate with a 200-nm silicon oxide layer serving as a gate dielectric layer. The silicon oxide layer was then modified with octyltrichlorosilane agent to obtain a hydrophobic surface. 12 milligrams of the DPP copolymer was dissolved in 2 grams of 1,1,2,2-tetrachloroethane solvent with the assistance of heat and shaking to form a dark blue solution. After filtering with a 0.2 um syringe filter, the solution was spin coated at 2000 rpm onto the modified silicon wafer substrate. A very smooth and shiny semiconductor film was obtained. After being dried at 70° C. for about 30 minutes and annealed in a vacuum oven at 150° C. for 10 minutes, gold source/drain electrodes were vapor-evaporated on top of the semiconducting layer to form a series of transistors. At least 10 transistors were evaluated using a Keithley SCS4200 at ambient conditions. All devices showed high current on/off ratio over 10⁶.

As a control, the same DPP copolymer was prepared using the Stille polycondensation method (i.e. organotin compound instead of organoboron compound) with Pd(PPh₃)₄ as catalyst.

The average field-effect mobility results are summarized in Table 3.

TABLE 3

| | Catalyst | Yield | | | μₐᵥₑ |
|---|---|---|---|---|---|
| Sample | loading (%) | (%) | Mₙ | PDI | (cm²/V · sec) |
| Control | 5 | 90 | 22,900 | 2.51 | 0.31 |
| A | 5 | 60 | 15,226 | 2.30 | 0.22 |
| B | 3 | 75 | 10,141 | 2.12 | 0.44 |
| E | 3 | 87 | 15,033 | 2.67 | 0.60 |

The polymers prepared according to the processes of the present disclosure showed similar or better electrical performance than the control sample made using the Stille polycondensation method. The polymer prepared in o-xylene (Sample E) also had the highest mobility on average.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A process for preparing a diketopyrrolopyrrole copolymer, comprising:
receiving a reaction mixture containing a diketopyrrolopyrrole monomer, an aryl comonomer, a palladium catalyst, and a solvent; and
reacting the reaction mixture to form the diketopyrrolopyrrole copolymer.

2. The process of claim 1, wherein the diketopyrrolopyrrole monomer has the structure of Formula (I): 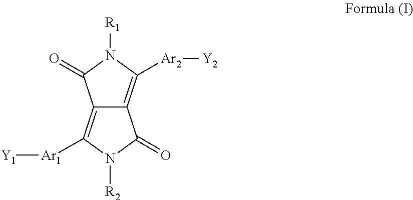
wherein Ar₁ and Ar₂ are independently aryl, substituted aryl, heteroaryl, or substituted heteroaryl;
R₁ and R₂ are independently hydrogen, alkyl, substituted alkyl, poly(ethylene glycol), poly(propylene glycol), aryl, substituted aryl, heteroaryl, or substituted heteroaryl; and
Y₁ and Y₂ are independently halogen.

3. The process of claim 1, wherein Ar₁ and Ar₂ are independently selected from the group consisting of thiophene, furan, thienothiophene, and selenophene.

4. The process of claim 1, wherein the aryl comonomer is an aryl boronate having the structure of Formula (III):
BE-Ar″-BE Formula (III)
wherein BE is selected from the group consisting of: 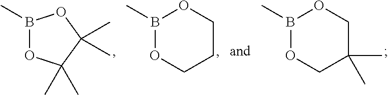
and wherein Ar″ is selected from the group consisting of: 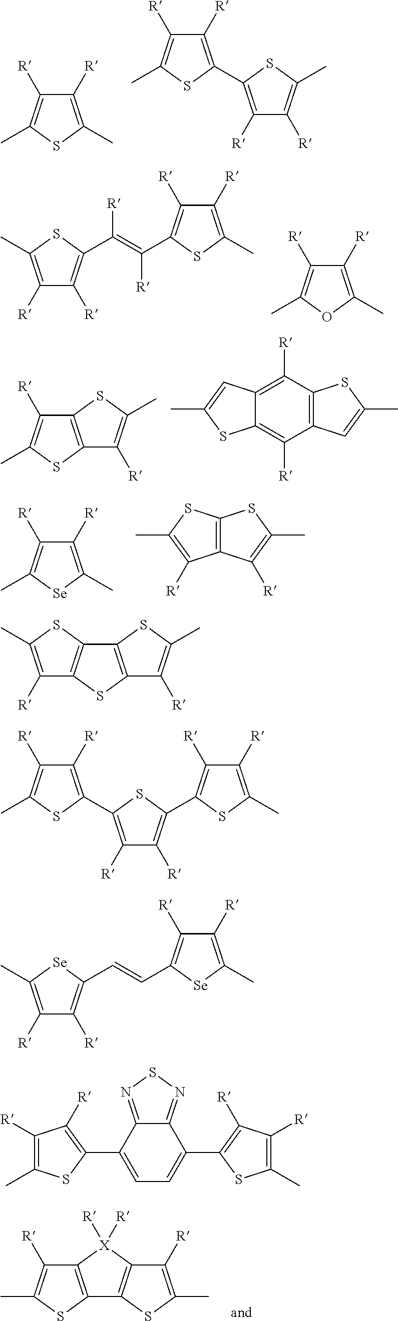 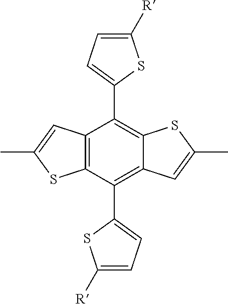
wherein each R′ is independently selected from hydrogen, alkyl, substituted alkyl, poly(ethylene glycol), poly(propylene glycol), aryl, substituted aryl, heteroaryl, substituted heteroaryl, halogen, alkoxy, alkylthio, trialkylsilyl, —CN, or —NO₂; and X is C or Si.

5. The process of claim 1, wherein the palladium catalyst is present in an amount of from about 3 mole % to about 5 mole % of the reaction mixture.

6. The process of claim 1, wherein the solvent includes an organic phase and an aqueous phase.

7. The process of claim 6, wherein the organic phase is selected from anisole, toluene, ethylbenzene, o-xylene, m-xylene, p-xylene, trimethylbenzene, mesitylene, tetrahydronapthalene, and mixtures thereof.

8. The process of claim 6, wherein the aqueous phase includes a base selected from K₂CO₃, K₃PO₄, KHCO₃, Na₂CO₃, NaHCO₃, and mixtures thereof.

9. The process of claim 6, wherein the volume ratio of organic phase to aqueous phase is from about 10:1 to about 2:1.

10. The process of claim 6, wherein the solvent is an about 3:1 mixture (v/v) of (i) either toluene or o-xylene with (ii) an aqueous solution containing about 1 to about 10 molar equivalents of a base.

11. The process of claim 1, wherein the reacting includes a microwave heating of the reaction mixture.

12. The process of claim 1, wherein the reacting occurs at a temperature of from 80° C. to 120° C.

13. The process of claim 1, wherein the reacting occurs for a time period of from about 6 hours to about 36 hours.

14. The process of claim 1, wherein the reaction mixture further comprises a phase transfer catalyst.

15. The process of claim 1, further comprising deoxygenating the reaction mixture prior to the reacting.

16. The process of claim 1, wherein the palladium catalyst has the structure of Formula (IV): 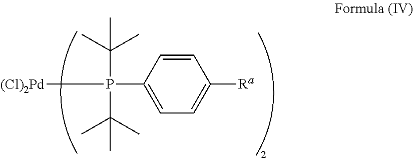
wherein R^{a} is H, —N(CH₃)₂, or —CF₃.

17. The process of claim 16, wherein Rₐ is —N(CH₃)₂.

18. The process of claim 1, wherein:
the palladium catalyst is present in the amount of from about 3 mole % to about 5 mole % of the reaction mixture;
the palladium catalyst has the structure of Formula (IV): 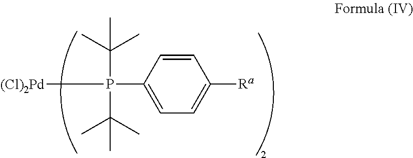
wherein R^{a} is H, —N(CH₃)₂, or —CF₃;
the solvent is a 3:1 mixture (v/v) of o-xylene with an aqueous solution containing from 1 to 10 molar equivalents of a base;
the reaction mixture further comprises a phase transfer catalyst; and
the reacting occurs at a temperature of about 80° to about 120° C. for a time period of at least 6 hours.

19. The process of claim 1, wherein the resulting diketopyrrolopyrrole copolymer has a number average molecular weight (Mn) of at least 10,000 when measured using high-temperature gel permeation chromatography in trichlorobenzene at 140° C.

20. The process of claim 1, wherein the resulting diketopyrrolopyrrole copolymer has a polydispersity index (PDI) of at least 2.0.
